(19) United States
(12) Patent Application Publication
(10) Pub. No.: US 2014/0370586 A1
(43) Pub. Date: Dec. 18, 2014

(54) MICROCHIP AND MICROCHIP-TYPE FINE-PARTICLE MEASURING DEVICE

(71) Applicant: Sony Corporation, Tokyo (JP)

(72) Inventors: Katsuhiro Seo, Kanagawa (JP); Koichi Tsukihara, Kanagawa (JP); Yoshiki Okamoto, Kanagawa (JP); Shunpei Suzuki, Chiba (JP)

(21) Appl. No.: 14/367,001

(22) PCT Filed: Oct. 25, 2012
(86) PCT No.: PCT/JP2012/006846

§ 371 Date: Jun. 19, 2014

(30) Foreign Application Priority Data
Dec. 28, 2011 (JP) 2011-288862

(51) Int. Cl. G01N 15/14; G01N 21/64; G01N 21/05; G01N 21/47

(52) U.S. Cl. CPC G01N 15/1484; G01N 21/47; G01N 21/64; G01N 21/05; G01N 2201/067
USPC 435/288.7; 422/82.09; 422/82.08

(57) ABSTRACT

A microchip is provided. The microchip includes an incident surface configured to receive light transmitted from a light source, the light being received from an incident direction and a back surface that is opposite the incident surface, the back surface including a portion that is configured to reflect light transmitted from the light source away from the incident direction.

### TECHNICAL FIELD

The present technology relates to a microchip and a microchip-type fine-particle measuring device. To be more specific, the present technology relates to a microchip or the like that is used to measure the optical characteristics of fine particles such as cells and that is capable of performing high-precision measurement.

### BACKGROUND ART

A fine-particle measuring device (such as a flow cytometer) for optically measuring the characteristics of fine particles such as cells is known.

A flow cytometer measures the optical characteristics of cells by causing a sample liquid including the cells to flow through a channel formed in a flow cell or in a microchip, and by irradiating the cells passing through the channel with a laser beam and detecting fluorescent light or scattered light generated from the cells with a detector.

For example, PTL 1 discloses, as a microchip-type flow cytometer, “a fine particle sorting apparatus including a microchip including a channel through which a liquid containing a fine particle flows and an orifice through which the liquid flowing through the channel is discharged to a space outside the chip; an oscillating element for transforming the liquid into a droplet at the orifice and discharging the droplet; a charging means for applying an electric charge to the droplet that is discharged; optical detection means that detects optical characteristics of the fine particle flowing through the channel; a pair of electrodes disposed so as to face each other with the droplet therebetween, the electrodes extending along a movement direction of the droplet that has been discharged to the space outside the chip; and two or more containers that collect the droplet that has passed between the pair of electrodes”.

### CITATION LIST

### Patent Literature

[PTL 1] Japanese Unexamined Patent Application Publication No. 2010-190680

### SUMMARY OF INVENTION

### Technical Problem

To measure the optical characteristics of a fine particle with high precision, it is required that a fine-particle measuring device include a detection system that detects fluorescent light and scattered light generated from the fine particle under laser beam irradiation with high efficiency and that prevents light that is noise, such as reflected light and interference light, from entering the detector. In particular, this is highly required for a detection system for a flow cytometer using a microchip made of a plastic, which has optical characteristics inferior to those of a flow cell made of a silica glass.

Therefore, the main object of the present technology is to provide a microchip for a fine-particle measuring device that is capable of selectively detecting fluorescent light and scattered light that emanate from a fine particle and serve as a signal while reducing detection of light that is noise.

### Solution to Problem

To solve the problem described above, the present technology provides a microchip comprising an incident surface configured to receive light transmitted from a light source, the light being received from an incident direction and a back surface that is opposite the incident surface, the back surface including a portion that is configured to reflect light transmitted from the light source away from the incident direction.

In the microchip, the portion of the back surface is nonparallel to the incident surface and located across from a portion of the incident surface that receives the light from the light source.

With the microchip, the light that passes through the incident surface is reflected in a direction that is different from the incident direction of the light, thereby reducing noise due to the reflected light.

The microchip may be made of a thermoplastic resin and may be made by injection molding.

Moreover, the present technology provides a microchip system comprising an incident surface configured to receive light transmitted from a light source, the light being received from an incident direction and a back surface that is opposite the incident surface, the back surface including a portion that is configured to reflect light transmitted from the light source away from the incident direction. The microchip system also includes a channel configured to host a particle for irradiation by the light source.

It is preferable that the microchip system include a first detector positioned on the incident surface side and configured to detect fluorescent light or backscattered light from the channel within a detection range. The microchip system can also include a second detector positioned adjacent to the back surface to detect forward-scattered light from the channel and a mask located between the second detector and the back surface configured to block light from the light source.

The microchip system can also include a detection system that guides the fluorescent light and/or the scattered light to the first detector, wherein the surface of the microchip is formed so as to be capable of reflecting the light that has passed through the incident surface to a point outside of a detection range of the first detector. The detection system of the microchip system may include an optical fiber that transmits the fluorescent light and/or the scattered light generated from the particle to the first and/or second detector and a lens that couples the fluorescent light and/or the scattered light to the optical fiber, and in this case, it is preferable that the surface of the microchip be formed so as to be capable of reflecting the light that has passed through the incident surface to a point outside of a region that is optically conjugate to a spot of the fluorescent light and/or the scattered light at an incident end of the optical fiber.

With the microchip system, the light that has passed through the incident surface is reflected to a point outside of the detection range of the detector or outside of the conjugate region, thereby suppressing the generation of noise due to reflected light and thereby selectively detecting fluorescent light and/or scattered light generated from the fine particle.

Alternatively, in the microchip system, the surface of the microchip may be formed so as to be capable of reflecting the light that has passed through the incident surface in a direction such that the particle flowing through the channel is not irradiated with the light. Since the light that has passed through the incident surface is reflected in a direction in which the particle is not irradiated with the light, generation of noise due to reflected light is suppressed, and thereby fluorescent light and/or scattered light generated from the particle can be selectively detected.

In a case where the microchip system includes a detector that detects the scattered light generated from the particle, when the back surface of the microchip is formed so as to include a surface that is not parallel to the incident surface, the detector that detects the scattered light is disposed at an angle to an optical axis of the light that is incident on the incident surface in accordance with an inclination of the surface with respect to the incident surface.

In the present technology, a “particle” or “fine particle” broadly includes a fine bioparticle such as a cell, a microorganism, and a liposome; or a synthetic particle such as a latex particle, a gel particle, and a particle for industrial use.

A fine bioparticle includes a chromosome, a liposome, a mitochondrion, and an organelle (a small organism in a cell), which are included in various cells. A cell includes an animal cell (such as a blood cell) and a plant cell. A microorganism includes a bacterium such as Escherichia coli, a virus such as a tobacco mosaic virus, and a fungus such as a yeast. Moreover, a fine bioparticle includes a biopolymer such as a nucleic acid, a protein, and a complex of these. Furthermore, a particle for industrial use may be, for example, an organic or inorganic polymeric material or a metal. An organic polymeric material includes polystyrene, styrene, divinylbenzene, polymethyl methacrylate, and the like. An inorganic polymeric material includes glass, silica, and a magnetic material. A metal includes a gold colloid and aluminium. Although, in general, the shape of such a fine particle is usually spherical, the shape may be nonspherical, and the size and the mass are not particularly limited.

### Advantageous Effects of Invention

The present technology provides a microchip for a fine-particle measuring device that is capable of selectively detecting fluorescent light and scattered light that are generated from a fine particle and that serve as a signal while reducing detection of light that is noise.

### BRIEF DESCRIPTION OF DRAWINGS

FIG. 1 is a schematic view illustrating the structure of an irradiation system and a detection system of a microchip-type fine-particle measuring device according to the present technology.

FIG. 2 is a schematic view illustrating the structure of a microchip according to a first embodiment of the present technology.

FIG. 3 is a schematic view illustrating the structure of a microchip according to a second embodiment of the present technology.

### DESCRIPTION OF EMBODIMENTS

Hereinafter, preferred embodiments of the present technology will be described with reference to the drawings. Note that, the embodiments described below are examples of a representative embodiment of the present technology, and the scope of the present technology is not narrowly interpreted on the basis thereof. The description will be made in the following order.

1. Microchip-type Fine-Particle Measuring Device

2. Microchip

(1) Microchip according to First Embodiment

(2) Microchip according to Second Embodiment

### 1. Microchip-type Fine-Particle Measuring Device

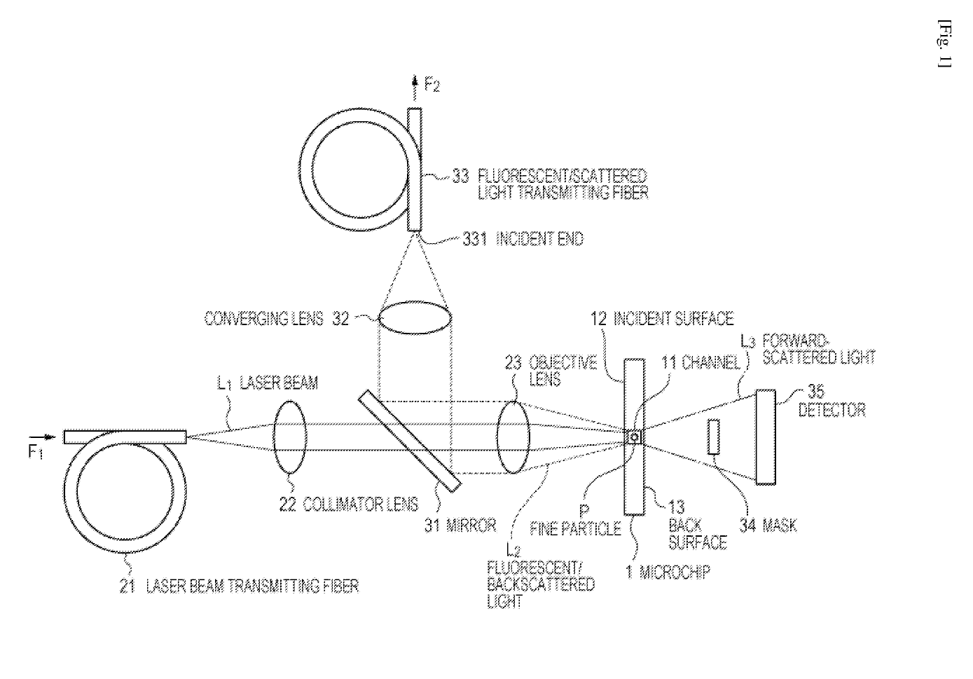

FIG. 1 is a schematic view illustrating the structure of an irradiation system and a detection system of a microchip-type fine-particle measuring device according to the present technology.

The irradiation system functions to irradiate a fine particle P, which flows through a channel 11 formed in a microchip 1, with a laser beam L₁. The irradiation system includes a laser beam transmitting fiber 21 that transmits the laser beam L₁ emitted from a light source (not shown), a collimator lens 22 that transforms the laser beam L₁ into a parallel beam, and an objective lens 23 that focuses the laser beam L₁ onto the channel 11. A numeral 12 in the figure denotes an incident surface of the microchip 1 on which the laser beam L₁ is incident, and a numeral 13 denotes a back surface that is opposite to the incident surface. Moreover, an arrow F₁ in the figure indicates a direction in which the laser beam L₁, which has been emitted from the light source, enters the laser beam transmitting fiber 21.

The detection system functions to detect fluorescent light and/or backscattered light generated from the fine particle P due to irradiation with the laser beam L₁. The detection system includes the objective lens 23 that focuses fluorescent/backscattered light L₂ generated from the fine particle P, a mirror 31 that reflects the fluorescent/backscattered light L₂, a converging lens 32 that couples the fluorescent/backscattered light L₂ to an incident end 331 of a fluorescent/scattered light transmitting fiber 33, and a detector (not shown) that detects the fluorescent/backscattered light L₂ transmitted by the fluorescent/scattered light transmitting fiber 33. An arrow F₂ in the figure indicates a direction in which the fluorescent/backscattered light L₂, which has been emitted from the fluorescent/scattered light transmitting fiber 33, enters the detector.

Moreover, the detection system includes a detector 35 that detects forward-scattered light L₃ generated from the fine particle P. A numeral 34 in the figure denotes a mask that blocks the laser beam L₁. The mask 34 functions to guide only the forward-scattered light L₃ to the detector 35 by blocking the laser beam L₁.

Apart from the structure illustrated in FIG. 1, the irradiation system and the detection system may include optical elements that are usually used, such as a lens, a dichroic mirror, and a band-pass filter. Moreover, the detectors, including the detector 35, can be made from, for example, a PMT (photo multiplier tube), an area imaging device such as a CCD or a CMOS device, or the like. Fluorescent light and various kinds of scattered light that have been detected by the detectors are transformed into electric signals, which are output and used for determining the optical characteristics of the fine particle P.

### 2. Microchip

### (1) Microchip according to First Embodiment

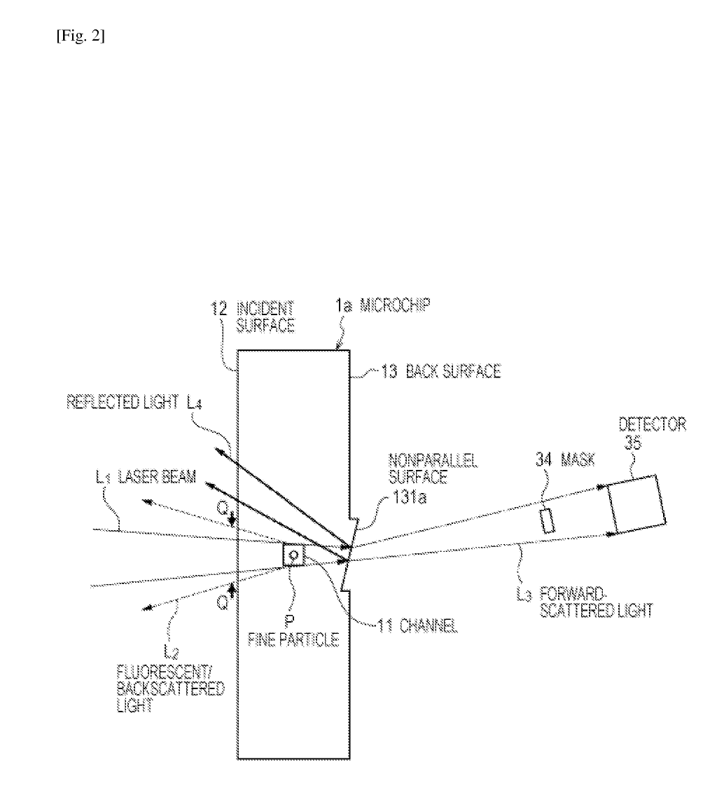

FIG. 2 is a schematic view illustrating the structure of an embodiment that is preferable as the microchip 1.

The microchip, which is denoted by a numeral la in the figure, has the back surface 13 including a nonparallel surface 131a that is capable of reflecting the laser beam L₁ that has passed through the incident surface 12 in a direction different from an incident direction.

The nonparallel surface 131a is formed as a surface that is not parallel to the incident surface 12. The nonparallel surface 131a is formed in a portion of the back surface 13 that can be reached by at least the laser beam L₁ that has passed through the incident surface 12 and the forward-scattered light L₃ that has been generated from the fine particle P. In the example described here, the nonparallel surface 131a is a single surface formed in the portion, but the nonparallel surface 131a may include a plurality of surfaces that are arranged in a sawtooth shape in the sectional view illustrated in the figure.

If the laser beam L₁ that has passed through the incident surface 12 is reflected by the back surface 13 and the fine particle P is irradiated with the reflected light, fluorescent light and scattered light may be generated from the fine particle P due to the reflected light. The fluorescent light and the scattered light generated due to the reflected light are noise for the fluorescent/backscattered light L₂ to be detected, which is generated from the fine particle P due to direct irradiation with the laser beam L₁ that has passed through the incident surface 12.

With the microchip 1a, even if such fluorescent light and scattered light are generated due to the reflected light, they are prevented from being detected since the nonparallel surface 131a is formed and thereby the laser beam L₁ that has passed through the incident surface 12 is reflected in a direction different from the incident direction. To be specific, the nonparallel surface 131a is inclined at a predetermined angle with respect to the incident surface 12, so that reflected light L₄ of the laser beam L₁ from the nonparallel surface 131a is reflected in a direction different from the incident direction.

It is preferable that the inclination angle of the nonparallel surface 131a with respect to the incident surface 12 be set so that the reflected light L₄ is reflected to a point outside of the detection range (see arrows Q-Q in the figure) of the detector for detecting the fluorescent/backscattered light L₂. The detection range (see arrows Q-Q in the figure) of the detector corresponds to a region (referred to as a “detection window”) that is optically conjugate to a spot of the fluorescent/backscattered light L₂ at the incident end 331 of the fluorescent/scattered light transmitting fiber 33. Therefore, in other words, it is preferable that the inclination angle be set so that the reflected light L₄ is reflected to a point outside of the detection window. By setting in this way, even if fluorescent light and scattered light are generated due to the reflected light L₄, they are prevented from entering the detector for detecting the fluorescent/backscattered light L₂.

Alternatively, the inclination angle of the nonparallel surface 131a with respect to the incident surface 12 is set so that the reflected light L₄ is not incident on a three-dimensional laminar flow in the channel 11 (a laminar flow including a laminar flow of sample liquid including the fine particle P and a laminar flow of a sheath liquid surrounding the laminar flow). Preferably, the inclination angle is set so that the reflected light L₄ is not incident on the channel 11. By setting in this way, fluorescent light and scattered light are not generated due to the reflected light L₄, so that they are prevented from entering the detector for detecting the fluorescent/backscattered light L₂.

By reflecting the reflected light L₄ of the laser beam L₁ to a point outside of the detection range of the detector or the detection window with the nonparallel surface 131a, the microchip 1a and the microchip-type fine-particle measuring device including the microchip 1a can selectively detect the fluorescent/backscattered light L₂ while suppressing generation of noise due to the reflected light L₄. Therefore, the microchip 1a and the microchip-type fine-particle measuring device including the microchip 1a can detect the fluorescent/backscattered light L₂ generated from the fine particle P with high efficiency and can measure the optical characteristics of the fine particle with high precision. Note that the sizes of the detection range and detection window of the detector are determined in accordance with the core diameter of the fluorescent/scattered light transmitting fiber 33 and the optical magnification of the detection system.

Note that, in a microchip-type fine-particle measuring device including the microchip 1a, the detector 35 for detecting the forward-scattered light L₃ is disposed at an angle to the optical axis of the laser beam L₁ in accordance with the inclination angle of the nonparallel surface 131a with respect to the incident surface 12. Thus, the measuring device is designed such that the fine particle P and the detector 35 are optically conjugate to each other.

Here, the nonparallel surface 131a is formed in a portion of the back surface 13 that can be reached by the laser beam L₁ that has passed through the incident surface 12, but the entirety of the back surface 13 may be formed as a nonparallel surface that is not parallel to the incident surface 12. The microchip 1a can be formed by injection-molding a thermoplastic resin such as polycarbonate, a polymethyl methacrylate resin (PMMA), a cyclic polyolefin, polyethylene, polystyrene, polypropylene, or poly-dimethylsiloxane (PDMS); and can be obtained by affixing a substrate layer in which the channel 11 and the nonparallel surface 131a have been formed by using a die. However, the method of forming the microchip 1a is not limited to injection molding.

### (2) Microchip according to Second Embodiment

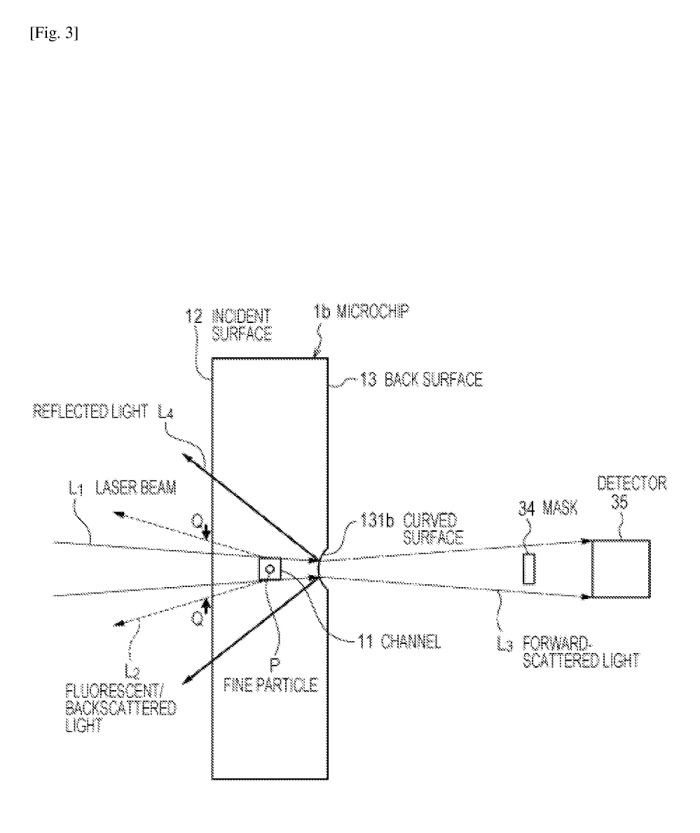

FIG. 3 is a schematic view illustrating another structure of an embodiment that is preferable as the microchip 1.

The microchip, which is denoted by a numeral lb in the figure, has a back surface 13 including a curved surface 131b that is capable of reflecting the laser beam L₁ that has passed through the incident surface 12 in a direction different from the incident direction.

The curved surface 131b is formed as a surface having a predetermined curvature. The curved surface 131b is formed in a portion of the back surface 13 that can be reached by at least the laser beam L₁ that has passed through the incident surface 12 and the forward-scattered light L₃ generated from the fine particle P. Here, the portion is formed as a single curved surface 131b, but a plurality of curved surfaces 131b may be arranged in the portion.

With the microchip 1b, generation of fluorescent light and scattered light from the fine particle P due to irradiation with the reflected light is suppressed, since the curved surface 131b is formed and thereby the laser beam L₁ that has passed through the incident surface 12 is widely scattered and most of the laser beam L₁ is reflected in a direction different from the incident direction. To be specific, since the curved surface 131b has a predetermined curvature, the reflected light L₄ of the laser beam L₁ from the curved surface 131b is scattered in many directions.

It is preferable that the curvature of the curved surface 131b be set so that most of the reflected light L₄ is reflected to a point outside of the detection range (see arrows Q-Q in the figure) of the detector for detecting the fluorescent/backscattered light L₂. In other words, it is preferable that the curvature be set so that most of the reflected light L₄ is reflected to a point outside of the detection window. By setting in this way, even if fluorescent light and scattered light are generated due to the reflected light L₄, the proportion of them that enter the detector for detecting the fluorescent/backscattered light L₂ is considerably reduced.

Alternatively, the curvature of the curved surface 131b is set so that most of the reflected light L₄ is not incident on the three-dimensional laminar flow in the channel 11. Preferably, the curvature is set so that most of the reflected light L₄ is not incident on the channel 11. By setting in this way, fluorescent light and scattered light are only negligibly generated due to the reflected light L₄, so that they are prevented from entering the detector for detecting the fluorescent/backscattered light L₂.

By reflecting the reflected light L₄ of the laser beam L₁ to a point outside of the detection range of the detector or the detection window with the curved surface 131b, the microchip 1b and the microchip-type fine-particle measuring device including the microchip 1b can selectively detect the fluorescent/backscattered light L₂ while suppressing generation of noise due to the reflected light L₄. Therefore, the microchip 1b and the microchip-type fine-particle measuring device including the microchip 1b can detect the fluorescent/backscattered light L₂ generated from the fine particle P with high efficiency and can measure the optical characteristics of the fine particle with high precision.

Note that, since the curved surface 131b serves as a lens in the microchip-type fine-particle measuring device including the microchip 1b, the size and/or the position of the detector 35 for detecting the forward-scattered light L₃ are/is adjusted in accordance with the curvature of the curved surface 131b. Thus, the measuring device is designed such that the fine particle P and the detector 35 are optically conjugate to each other. Moreover, in a case where a converging lens for focusing the forward-scattered light L₃ is disposed between the microchip 1b and the detector 35, the converging lens is designed with consideration of the function the curved surface 131b as a lens.

Here, the curved surface 131b is formed only in a portion of the back surface 13 that can be reached by the laser beam L₁ that has passed through the incident surface 12, but the entirety of the back surface 13 may be formed as a surface having a predetermined curvature. The microchip 1b can also be formed by injection-molding a thermoplastic resin described above, and by affixing a substrate layer in which the channel 11 and the curved surface 131b have been formed by using a die. However, the method of forming the microchip 1b is not limited to injection molding.

A microchip according to the present technology may be structured as follows.

(1) In an embodiment, a microchip comprises an incident surface configured to receive light transmitted from a light source, the light being received from an incident direction and a back surface that is opposite the incident surface, the back surface including a portion that is configured to reflect light transmitted from the light source away from the incident direction.

(2) The microchip of (1), further comprising a channel configured to host a particle for irradiation by the light source.

(3) The microchip of (2), wherein the portion of the back surface is inclined at an angle to reflect light received from the light source outside of a laminar flow of the channel.

(4) The microchip of (3), wherein the laminar flow of the channel is tangential to the incident direction.

(5) The microchip of (3), wherein the laminar flow of the channel is parallel to the back surface.

(6) The microchip of (1), wherein the portion of the back surface is nonparallel to the incident surface and located across from a portion of the incident surface that receives the light from the light source.

(7) The microchip of (6), wherein the portion of the back surface is inclined at an angle to reflect light from the light source outside of a detection range of a detector.

(8) The microchip of (7), wherein the detection range includes a region that is optically conjugate to fluorescent or backscattered light at the incident surface side.

(9) The microchip of (6), wherein the portion of the back surface includes a single angled surface.

(10) The microchip of (6), wherein the portion of the back surface includes a plurality of surfaces that are arranged in a sawtooth shape.

(11) The microchip of (6), wherein the portion of the back surface is configured to be positioned at an angle that is less than perpendicular to the incident surface.

(12) The measuring device (1), wherein the portion of the back surface is a curved surface and located across from a portion of the incident surface that receives the light.

(13) The microchip of (12), wherein the curved surface includes a plurality of curved surfaces.

(14) The measuring device of (12), wherein the curved surface includes a curvature that reflects light from the light source outside of a detection range of a first detector.

(15) The microchip of (1), wherein the microchip is formed using injection molding.

(16) The microchip of (1), wherein microchip includes a thermoplastic resin.

(17) The microchip of (15), wherein the thermoplastic resin is selected from a group consisting of polycarbonate, polymethyl methacrylate resin, cyclic polyolefin, polyethylene, polystyrene, polypropylene, polydimethylsiloxane, and combinations thereof.

(18) In another embodiment, a microchip system comprises an incident surface configured to receive light transmitted from a light source, the light being received from an incident direction, a back surface that is opposite the incident surface, the back surface including a portion that is configured to reflect light transmitted from the light source away from the incident direction, and a channel configured to host a particle for irradiation by the light source.

(19) The microchip system of (18), further comprising a first detector positioned on the incident surface side and configured to detect fluorescent light or backscattered light from the channel within a detection range, a second detector positioned adjacent to the back surface to detect forward-scattered light from the channel, and a mask located between the second detector and the back surface configured to block light from the light source.

(20) The microchip system of (19), wherein the portion of the back surface is non-parallel to the incident surface and located across from a portion of the incident surface that receives the light from the light source.

(21) The measuring system of (20), wherein the second detector and the mask are positioned at an angle to the incident direction in accordance with an angle of the portion of the back surface.

(22) The measuring system of (20), wherein the portion of the back surface is angled to reflect the light out of a plane in which the light is received.

(23) The measuring system of (19), wherein the portion of the back surface includes a curved surface with a curvature such that the reflected light is not incident on a laminar flow in the channel and the reflected light is outside of the detection range of the first detector.

(24) The measuring system of (23), wherein the curved surface includes a lens, and the second detector is positioned to be optically conjugate to the channel based on the curvature of the lens.

(25) The measuring system of (19), wherein the incident surface, the back surface, the channel, the first detector, the second detector, and the mask comprise a flow cytometer.

(26) In a further embodiment, a microchip in which a surface opposite to an incident surface on which a laser beam is incident is formed so as to be capable of reflecting the laser beam that has passed through the incident surface in a direction that is different from an incident direction in which the laser beam is incident on the incident surface.

(27) The microchip according to (26), wherein the surface is formed so as to include a surface that is not parallel to the incident surface.

(28) The microchip according to (26), wherein the surface is formed so as to include a surface having a curvature.

(29) The microchip according to any one of (26) to (28) that is made of a thermoplastic resin.

(30) The microchip according to any one of (26) to (29) that is made by injection molding.

Moreover, a microchip-type fine-particle measuring device according to the present technology may be structured as follows.

(31) A microchip-type fine-particle measuring device comprising a microchip in which a channel through which a fine particle flows is formed and an irradiation system that guides a laser beam emitted from a light source to the channel of the microchip, wherein, in the microchip, a surface opposite to an incident surface on which the laser beam is incident is formed so as to be capable of reflecting the laser beam that has passed through the incident surface in a direction that is different from an incident direction in which the laser beam is incident on the incident surface.

(32) The microchip-type fine-particle measuring device according to (31) comprising a detector that detects fluorescent light and/or scattered light generated from the fine particle irradiated with the laser beam and a detection system that guides the fluorescent light and/or the scattered light to the detector, wherein the surface of the microchip is formed so as to be capable of reflecting the laser beam that has passed through the incident surface to a point outside of a detection range of the detector.

(33) The microchip-type fine-particle measuring device according to (32) wherein the detection system includes an optical fiber that transmits the fluorescent light and/or the scattered light generated from the fine particle to the detector and a lens that couples the fluorescent light and/or the scattered light to the optical fiber, and wherein the surface of the microchip is formed so as to be capable of reflecting the laser beam that has passed through the incident surface to a point outside of a region that is optically conjugate to a spot of the fluorescent light and/or the scattered light at an incident end of the optical fiber.

(34) The microchip-type fine-particle measuring device according to any one of (31) to (33), wherein the surface of the microchip is formed so as to be capable of reflecting the laser beam that has passed through the incident surface in a direction such that the fine particle flowing through the channel is not irradiated with the laser beam.

(35) The microchip-type fine-particle measuring device according to any one of (31) to (34), comprising a detector that detects the scattered light generated from the particle, wherein the surface of the microchip is formed so as to include a surface that is not parallel to the incident surface, and wherein the detector that detects the scattered light is disposed at an angle to an optical axis of the laser beam that is incident on the incident surface in accordance with an inclination of the surface with respect to the incident surface.

### REFERENCE SIGNS LIST

1, 1a, 1b microchip

11 channel

12 incident surface

13 back surface

131a nonparallel surface

131b curved surface

21 laser beam transmitting fiber

22 collimator lens

23 objective lens

31 mirror

32 converging lens

33 fluorescent/scattered light transmitting fiber

331 incident end

34 mask

35 detector

L₁ laser beam

L₂ fluorescent/backscattered light

L₃ forward-scattered light

L₄ reflected light

P fine particle

1. A microchip comprising:
an incident surface configured to receive light transmitted from a light source, the light being received from an incident direction; and
a back surface that is opposite the incident surface, the back surface including a portion that is configured to reflect light transmitted from the light source away from the incident direction.

2. The microchip of claim 1, further comprising a channel configured to host a particle for irradiation by the light source.

3. The microchip of claim 2, wherein the portion of the back surface is inclined at an angle to reflect light received from the light source outside of a laminar flow of the channel.

4. The microchip of claim 3, wherein the laminar flow of the channel is tangential to the incident direction.

5. The microchip of claim 3, wherein the laminar flow of the channel is parallel to the back surface.

6. The microchip of claim 1, wherein the portion of the back surface is nonparallel to the incident surface and located across from a portion of the incident surface that receives the light from the light source.

7. The microchip of claim 6, wherein the portion of the back surface is inclined at an angle to reflect light from the light source outside of a detection range of a detector.

8. The microchip of claim 7, wherein the detection range includes a region that is optically conjugate to fluorescent or backscattered light at the incident surface side.

9. The microchip of claim 6, wherein the portion of the back surface includes a single angled surface.

10. The microchip of claim 6, wherein the portion of the back surface includes a plurality of surfaces that are arranged in a sawtooth shape.

11. The measuring device of claim 1, wherein the portion of the back surface is a curved surface and located across from a portion of the incident surface that receives the light.

12. The microchip of claim 11, wherein the curved surface includes a plurality of curved surfaces.

13. The measuring device of claim 11, wherein the curved surface includes a curvature that reflects light from the light source outside of a detection range of a first detector.

14. The microchip of claim 1, wherein the microchip is formed using injection molding.

15. The microchip of claim 1, wherein microchip includes a thermoplastic resin.

16. The microchip of claim 15, wherein the thermoplastic resin is selected from a group consisting of polycarbonate, polymethyl methacrylate resin, cyclic polyolefin, polyethylene, polystyrene, polypropylene, polydimethylsiloxane, and combinations thereof.

17. A microchip system comprising:
an incident surface configured to receive light transmitted from a light source, the light being received from an incident direction;
a back surface that is opposite the incident surface, the back surface including a portion that is configured to reflect light transmitted from the light source away from the incident direction; and
a channel configured to host a particle for irradiation by the light source.

18. The microchip system of claim 17, further comprising:
a first detector positioned on the incident surface side and configured to detect fluorescent light or backscattered light from the channel within a detection range;
a second detector positioned adjacent to the back surface to detect forward-scattered light from the channel; and
a mask located between the second detector and the back surface configured to block light from the light source.

19. The measuring system of claim 18, wherein the portion of the back surface includes a curved surface with a curvature such that the reflected light is not incident on a laminar flow in the channel and the reflected light is outside of the detection range of the first detector.

20. The measuring system of claim 18, wherein the incident surface, the back surface, the channel, the first detector, the second detector, and the mask comprise a flow cytometer.
